(19) United States
(12) Patent Application Publication
(10) Pub. No.: US 2017/0286624 A1
(43) Pub. Date: Oct. 5, 2017

(54) Methods, Systems, and Devices for Evaluating a Health Condition of an Internet User

(71) Applicant: Alibaba Group Holding Limited, Grand Cayman (KY)

(72) Inventors: Yu XU, Hangzhou (CN); Yinzi REN, Hangzhou (CN); Yan SUN, Hangzhou (CN); Bangyu XIANG, Hangzhou (CN); Yaguang LIU, Hangzhou (CN); Jianwei YANG, Hangzhou (CN)

(21) Appl. No.: 15/473,016

(22) Filed: Mar. 29, 2017

(30) Foreign Application Priority Data
Mar. 31, 2016 (CN) 201610201241.1

(51) Int. Cl. G06F 19/00; H04L 29/08

(52) U.S. Cl. CPC G06F 19/3431; H04L 67/22; G06F 19/322; G06F 19/3437

(57) ABSTRACT

Disclosed herein are methods, systems and devices for evaluating a health condition of an Internet user. In one embodiment, the method comprises acquiring Internet activity data associated with a plurality of users, the plurality of users including a first user; selecting a set of sample users from the plurality of users based on a plurality of specified Internet activities identified in Internet activity data associated with the first user; extracting characteristic data for the first user and the set of sample users from the Internet activity data; utilizing the characteristic data as at least one parameter of a health index calculation model; and calculating a health index for the first user based on the health index calculation model.

### CROSS-REFERENCE TO RELATED APPLICATIONS

This application claims the benefit of priority of Chinese Application No. 201610201241.1, titled “Method, System and Apparatus for Evaluation of the Health of Internet Users,” filed on Mar. 31, 2016, which is hereby incorporated by reference in its entirety.

### BACKGROUND

### Technical Field

The disclosure relates to the field of communications, and in particular to methods, systems and devices for evaluating a health condition of an Internet user.

### Description of Related Art

Currently, some Internet applications assume the role of a platform for facilitating communications between service providers and service requesters. Specifically, a service provider and a service requester each register on the platform and the service provider provides relevant services to the service requester. In any given scenario, the service provider must be healthy. Therefore, the recent health condition of the service provider is required as a reference index when facilitating connections between a service provider and a service requester.

Current techniques evaluate a health condition of a user based on medical test data. In general, current techniques receive medical test data sets (e.g., blood pressure, blood sugar and body mass index, bone mineral density, cardiovascular, arteriosclerosis, blood oxygen, and other medical test) data and screen the medical test data sets. The current techniques then apply various measurement methods (e.g., the equal ratio and/or interval value methods) to calculate a single index score for each of the medical test data sets collected. Finally, current techniques calculate a comprehensive health index based on the weighted average of the single index scores.

The current techniques suffer from numerous disadvantages discussed below.

First, medical test data of a user is difficult to obtain. Although medical test data of a user can reflect the health condition of the user, the user is often not willing to provide this data as such data is highly private. Thus, the feasibility of current techniques for testing the health condition of the user based on the user's medical test data is extremely low.

Second, the cost of updating a user's health condition based on obtained medical test data is high. Since the collection cost of the medical test data is relatively high, a health condition obtained based on the medical test data is likely not updated periodically since each update implicates a collection cost required to obtain updated medical test data.

Third, the credibility of a health condition obtained based on the medical test data is low. When current techniques weight the single index scores during the calculation of the comprehensive health score, the selection of the weight is highly subjective. This results in the reduction of credibility of the health condition obtained based on the medical test data as the comprehensive health score is subject to the subjective determinations made when weighting the single index scores.

### BRIEF SUMMARY

To remedy the above-described deficiencies, the present disclosure describes methods, systems and devices for evaluating a health condition of an Internet user.

In one embodiment, the method comprises acquiring Internet activity data associated with a plurality of users, the plurality of users including a first user; selecting a set of sample users from the plurality of users based on a plurality of specified Internet activities identified in Internet activity data associated with the first user; extracting characteristic data for the first user and the set of sample users from the Internet activity data; utilizing the characteristic data as at least one parameter of a health index calculation model; and calculating a health index for the first user based on the health index calculation model.

In one embodiment, an apparatus comprises one or more processors and a non-transitory memory storing computer-executable instructions therein that, when executed by the processor, cause the apparatus to perform the operations of acquiring Internet activity data associated with a plurality of users, the plurality of users including a first user; selecting a set of sample users from the plurality of users based on a plurality of specified Internet activities identified in Internet activity data associated with the first user; extracting characteristic data for the first user and the set of sample users from the Internet activity data; utilizing the characteristic data as at least one parameter of a health index calculation model; and calculating a health index for the first user based on the health index calculation model.

In some embodiments, characteristic data comprises any one of body mass index (“BMI”); a degree of an addiction to gaming; a degree of preference for junk foods; age; sex; whether the user stays up late frequently; the frequency of purchasing medical products over a given time period (e.g., the last two weeks); or whether the user performs manual labor.

The systems, devices, and methods disclosed herein evaluate the health condition of the user based on Internet activity data, which establishes a new mode for evaluating the health condition of a user versus current techniques. In addition, the systems, devices, and methods described herein provide low cost, high feasibility and fast updates.

In order to achieve the aforementioned purposes, the disclosure also describes a device for evaluating a health condition of an Internet user, comprising the system for evaluating the health condition of the Internet user according to any of the claims mentioned below. Based on the Internet activity data of user, the health condition of the user can be evaluated by the device for evaluating the health condition of an Internet user provided by the embodiment of the disclosure, comprising a system for evaluating the health condition of the Internet user, which establishes a new mode for evaluating the health condition, with low cost, high feasibility and fast updates.

### BRIEF DESCRIPTION OF THE DRAWINGS

The described drawings herein are used to provide a further understanding of the disclosure and constitute a portion of the application. Exemplary embodiments and descriptions thereof of the disclosure are intended to explain the disclosure rather than improperly limit the disclosure.

FIG. 1 is a flow diagram illustrating a method for evaluating a health condition of an Internet user, according to some embodiments of the disclosure.

FIG. 2 is a flow diagram illustrating a method for evaluating a health condition of an Internet user, according to some embodiments of the disclosure.

FIG. 3 is a block diagram illustrating a system for evaluating a health condition of an Internet user, according to some embodiments of the disclosure.

FIG. 4 is a block diagram illustrating a system for evaluating a health condition of an Internet user, according to some embodiments of the disclosure.

FIG. 5 is a block diagram illustrating a device for evaluating a health condition of an Internet user, according to some embodiments of the disclosure.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The detailed description provided herein is not intended as an extensive or detailed discussion of known concepts, and as such, details that are known generally to those of ordinary skill in the relevant art may have been omitted or may be handled in summary fashion. Certain embodiments of the disclosure will now be discussed with reference to the aforementioned figures, wherein like reference numerals refer to like components.

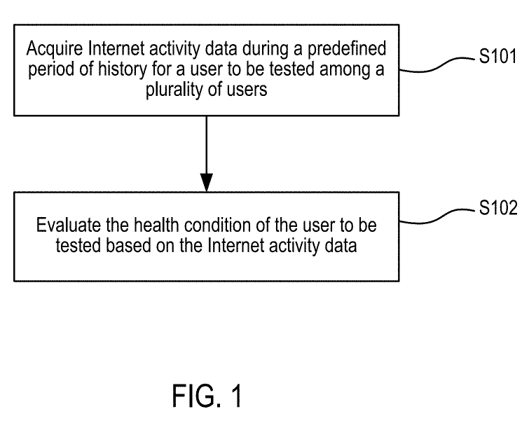

FIG. 1 is a flow diagram illustrating a method for evaluating a health condition of an Internet user, according to some embodiments of the disclosure.

In step S101, the method acquires Internet activity data during a predefined period of history for a user to be tested among a plurality of users.

From the Internet activity data, the method extracts characteristic data (discussed in more detail herein). In one embodiment, characteristic data comprises data such as e-commerce activity data, web browsing activity data, body mass index (BMI), a degree of an addiction to gaming, a degree of preference for junk foods, age, or sex, an indication of whether the user stays up late frequently, the frequency of purchasing medical products over a given time period (e.g., the last two weeks), and whether the user performs manual labor.

The set period of history may be the past two weeks, the past month, or the past year, etc. The set period of history may differ for different types of Internet activity data. For example, when the acquired Internet activity data is e-commerce activity data, the set period of history may be the past month, whereas when the acquired Internet activity data is whether a user stays up late frequently, the set period of history may be the past two weeks.

Internet activity data may be automatically recorded by a network server and may be acquired from the network server (e.g., via an API). As Internet activity data is not private data (e.g., personally identifiable information or health data), the Internet activity data does not need to be explicitly provided by the user and can be acquired easily and with low cost. Therefore, the feasibility of evaluating the health condition of the user based on Internet activity data is very high.

In step S102, the method evaluates the health condition of the user to be tested based on the obtained Internet activity data.

To some extent, Internet activity data can reflect the health condition of the user. Specifically, in the current Internet era, people's daily lives are oftentimes inseparable from their activities involving the Internet. Users engage in Internet activity nearly everywhere; therefore, the disclosure provides a method to evaluate the health condition of the user based on this Internet activity data. It has the revolutionary significance as compared to conventional ways of evaluating the health conditions based on medical test data. Moreover, not only is Internet activity data frequently updated, the cost of updates to Internet activity data is minimal. Thus, it is both fast and cost effective to update the health condition of the user based on constantly updating Internet activity data.

According to the embodiment illustrated in FIG. 1 and herein, the health condition of the user can be evaluated by a method for evaluating the health condition of the Internet user based on the Internet activity data, which establishes a new mode for evaluating the health condition. In addition, the method for evaluating the health condition of the Internet user in the illustrated embodiments provides low cost, high feasibility and fast updates.

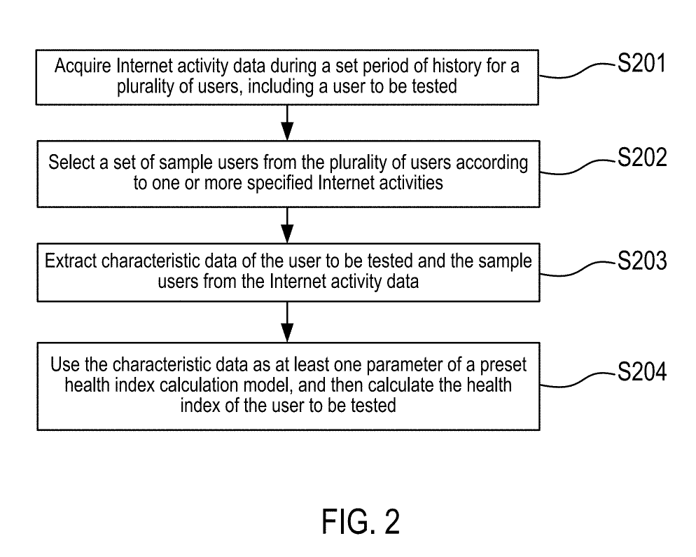

FIG. 2 is a flow diagram illustrating a method for evaluating a health condition of an Internet user according to some embodiments of the disclosure.

In step S201, the method acquires Internet activity data during a set period of history for a plurality of users, including a user to be tested.

In step S202, the method selects a set of sample users from the plurality of users according to one or more specified Internet activities.

In one embodiment, selecting sample users from the plurality of users according to specified Internet activity data in the Internet activity data may include selecting a positive sample user from the plurality of users according to a first specified Internet activity data in the Internet activity data, wherein the positive sample user does not include the user to be tested; and selecting a negative sample user from the plurality of users according to a second specified Internet activity data in the Internet activity data, wherein the negative sample user does not include the user to be tested.

On this basis, in other embodiments of the disclosure, selecting a set of sample users from the plurality of users according to specified Internet activity data in the Internet activity data can also further include eliminating overlapping sample users from the positive sample users and the negative sample users respectively, wherein the overlapping sample user refers to a sample user who is both a positive sample user and a negative sample user and balancing the ratio of the number of the positive sample user to the negative sample user so that the ratio of the numbers can be within a set threshold.

For example, the first specified Internet activity data may be purchasing activity data under a sports category within a preset first period of history, while the second specified Internet activity data may be the activity data of searching and browsing a medical registration website in a preset second period of history.

In one embodiment, the positive sample user refers to a healthy user, and the negative sample user refers to an unhealthy user.

In step S203, the method extracts characteristic data of the user to be tested and the sample users from the Internet activity data.

The characteristic data can comprise any one or more of the body mass index (BMI), a degree of an addiction to gaming, a degree of preference for junk foods, age, or sex, whether the user stays up late frequently, the frequency of purchasing medical products over a given time period (e.g., the last two weeks), and whether the user performs manual labor.

In step S204, the method uses the characteristic data as parameters of a preset health index calculation model, and then calculates the health index of the user to be tested.

In one embodiment, steps S202, S203, and S204 may be implemented as part, or the entirety of, step S102 discussed in connection with FIG. 1.

In one embodiment, calculating the parameter of a preset health index calculation model based on the characteristic data, and then obtaining the health index of the user to be tested may comprise: training the health index calculation model by applying the characteristic data of the sample users to obtain a parameter value in the health index calculation model; predicting the health probability of the user to be tested by using the characteristic data of the user to be tested as the input of the health index calculation model with the parameter value as the parameter; and carrying out normalization processing for the health probability of the user to be tested, in order to obtain the health index of the user to be tested.

The comparison between the characteristic data of the user to be tested and the corresponding characteristic data of the sample users is capable of objectively reflecting the health condition of the user to be tested, thus the reliability of the health condition evaluation result is higher.

The following content further explains the method for evaluating the health condition of the Internet user in one embodiment by a specific application example.

In the embodiment, the method for evaluating a health condition of an Internet user may comprise the following steps.

In step a, the method may receive Internet activity data during a set period of history for a user to be tested among a plurality of users

In step b, the method may select positive sample users according to the Internet activity data;

For example, it may be assumed that people who are fond of sports are in good health. Based on such an assumption, the method selects the set of positive samples according to the user's purchasing activity data under a sports category within the past month.

First, the method may conduct an initial cleaning (i.e., excluding) of the user's purchasing activity data under a sports category within the past one month. Considering that the online shopping data may include fake orders, the method may exclude obviously unusual data. The method may further set thresholds for the orders of the user under certain subcategories within the last one year, one month, two weeks, etc. and may then exclude users whose orders within the last one year, one month, two weeks, etc. exceed the set thresholds.

Afterwards, the method may add up the total purchasing frequency X within the last one month for each user with the initially cleaned data and calculate the average purchasing frequency μ and variance σ² of the users. Later, the method may standardize the purchasing frequency by utilizing the z-score method to obtain

$$\overline{X} = \frac{X - μ}{σ} \qquad Formula ( 1 )$$

In Formula 1, X̅>3 may indicate small probability events, which can be deemed as unusual values, thus the positive sample users can be selected from the users satisfying X̅<3. In addition, it may be required for the method to select the users with relatively higher purchasing frequency, thus the users satisfying 2<X̅<3 may be marked as positive the sample users.

In step c, the method may select negative sample users according to the Internet activity data.

In one embodiment, selecting negative sample users may comprises summing the searching and browsing frequencies of each user and selecting the users whose total frequency is greater than the set threshold as negative sample users according to the medical registration web site searching and browsing data of the users within the last one month.

In step d, the method may exclude the overlapping sample users from the positive and negative sample users.

The positive and negative sample users may be overlapping, and the overlapping sample users may be excluded from the positive and negative sample users. The overlapping sample user refers to a sample user who is both a positive sample user and a negative sample user.

In step e, the method may adjust and control the ratio between the positive and negative sample users. In one embodiment, the adjustment and control step is aimed to prevent a numerical imbalance between the positive and negative sample users.

In step f, the method extracts characteristic data of the user or users to be tested and the positive and negative users from the Internet activity data.

In one embodiment, the characteristic data comprises body mass index (BMI), a degree of an addiction to gaming, a degree of preference for junk foods, age, or sex, whether the user stays up late frequently, the frequency of purchasing medical products over a given time period (e.g., the last two weeks), and whether the user performs manual labor.

BMI may be used to measure the weight and health condition of the human body. It is a value of body mass divided by the square of the body height, that is, BMI=mass/height², wherein unit of mass is kilograms, while the unit of height is meters. In one embodiment, when calculating BMI, unusual values may be cleaned. For example, if the height is 0, the method may set the BMI as a null value. Alternatively, if a BMI value is less than 12 but greater than 40, the BMI may be deemed as unusual data and set as a null value.

As a second example, a user being addicted to gaming or fond of junk food may be an ambiguous concept, that is, a non-binary concept. In this example, the method may calculate the a degree of an addiction to or preference for, for example, gaming or junk food of the user based on the purchasing activity under a “gaming” category over the last month and the purchasing activity under a “junk food” category over the past two weeks. The calculated value is in an interval, and the degrees of addiction to gaming and the degree of preference for junk food of the user can be calculated through the following steps:
(1) Respectively set thresholds for the orders of the user under certain subcategory within the last one year, one month, or two weeks, etc., and then exclude the users whose orders within the last one year, one month, two weeks, etc. exceed the set thresholds;
(2) Add up the total purchasing frequency of the user according to the initially cleaned data, and calculate the first quartile Q1 and the third quartile Q3, and then compute the interquartile range (IQR);
(3) In one embodiment, the points in the interval of [Q3+1.5IQR, +∞) may be deemed as unusual points, and the degree that the purchasing frequency is greater than Q3+1.5IQR is deemed to be higher. However, considering that the result may be affected by unreliable data such as fake orders, a threshold of Q=Q3+2.5IQR shall be selected. If the purchasing frequency is much higher than the threshold Q, the data will be deemed as unreliable, and the corresponding degree value may be predicted to be lower. In addition, the corresponding degree of the purchasing frequency close to the threshold may be predicted to be higher. Thus, continuing the previous example, the degree of being addicted to games or being fond of junk food (or other non-binary characteristic data) may be calculated by the following formula (2),

e^{-|(X-Q)/Q|}^{^{α}} Formula (2)

Wherein, α is an adjustable parameter.

As a third example, the method may determine that a user stays up late frequently based on the user's time preference of Internet surfing from PC and mobile devices, and the user whose most usual browsing period is between midnight and 5:00 AM. Such a user may be identified as staying up late frequently.

As a fourth example, with respect to the frequency of purchasing medical products over the last two weeks, based on the purchasing data under the medicine category over the last two weeks, the method may first conduct an initial cleaning for the data with the same method used for the positive sample user selection above. The method may then add up the total frequency of the user under such category over the last two weeks, then set a threshold. If the total frequency of the user is greater than the threshold, the value shall be set as a null value.

As a fifth example, with respect to whether a user performs manual labor, according to the work that the user is engaged in (student, white collar, merchant, civil servant, manufacturing worker, medical staff, media, construction worker, shop assistant, waiter/waitress), users who work as manufacturing workers and construction workers are marked as being performing in manual labor.

In step g, the method calculates the health index according to the preset health index calculation model.

In many embodiments, there is often a significant amount of empty data in the characteristic data. Thus, in some embodiments the method may select a random forest algorithm as a classification model, and according to the sample and characteristics input to the health index calculation model, the health index calculation model firstly predicts whether the user is healthy, and then outputs the health probability (prb) of the user. The method may normalize the output probability value prb, suppose the maximum of the probability value prb in all users (positive and negative sample users and users to be tested) as max_prb, the minimum as min_prb, and calculate the health index according to the following formula (3):

$$health\_index = \frac{prb - min\_prb}{max\_prb - min\_prb} * 100 \qquad Formula ( 3 )$$

The health condition of the user is evaluated by the method for evaluating the health condition of the Internet user provided by the embodiment of the disclosure based on the Internet activity data, which establishes a new mode for evaluating the health condition, with low cost, high feasibility and fast updates. Moreover, in one embodiment, the method for evaluating a health condition of an Internet user is capable of objectively reflecting the health condition of the user to be tested, thus the reliability of the health condition evaluation result is higher.

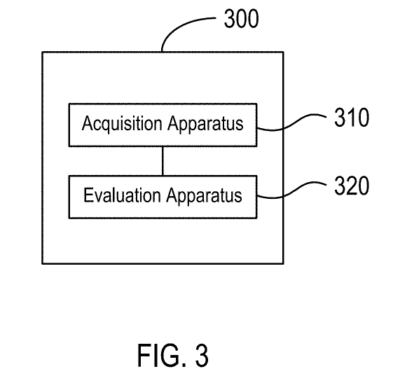

FIG. 3 is a block diagram illustrating a system for evaluating a health condition of an Internet user according to some embodiments of the disclosure.

As illustrated in FIG. 3, system 300 includes an acquisition apparatus 310 and an evaluation apparatus 320. In one embodiment, the acquisition apparatus 310 acquires Internet activity data during a set period of history for a user to be tested among a plurality of users. In one embodiment, the evaluation apparatus 320 evaluates the health condition of the user to be tested based on the Internet activity data acquired by the acquisition apparatus 310.

Internet activity data may comprise e-commerce activity data and/or web browsing activity data, for example, body mass index BMI, a degree of an addiction to gaming, a degree of preference for junk foods, age, or sex, whether the user stays up late frequently, the frequency of purchasing medical products over a given time period (e.g., the last two weeks), and whether the user performs manual labor.

The set period of history may be the past two weeks, the past month, or the past year, etc. The set period of history may differ for different types of Internet activity data. For example, when the acquired Internet activity data are e-commerce activity data, the set period of history can be the past month, whereas when the acquired Internet activity data is whether a user stays up late frequently, the set period of history may be the past two weeks.

Internet activity data may be automatically recorded by a network server and may be acquired from the network server (e.g., via an API). As Internet activity data is not private data (e.g., personally identifiable information or health data), the Internet activity data does not need to be explicitly provided by the user and can be acquired easily and with low cost. Therefore, the feasibility of evaluating the health condition of the user based on Internet activity data is very high.

To some extent, Internet activity data can reflect the health condition of the user. Specifically, in the current Internet era, people's daily lives are oftentimes inseparable from their activities involving the Internet. Internet activity is carried out nearly everywhere, therefore the disclosure provides a method to evaluate the health condition of the user based on Internet activity data. It has the revolutionary significance as compared to conventional ways of detecting the health conditions based on medical test data. Moreover, not only is Internet activity data frequently updated, but the cost of updates to Internet activity data are minimal. Thus it is both fast and cost effective to update the health condition of the user based on constantly updating Internet activity data.

According to the embodiments illustrated herein, the health condition of the user can be evaluated by a system for evaluating the health condition of an Internet user based on the Internet activity data, which establishes a new mode for evaluating the health condition. In addition, the system for evaluating a health condition of an Internet user in the illustrated embodiments of the disclosure provides low cost, high feasibility and fast updates.

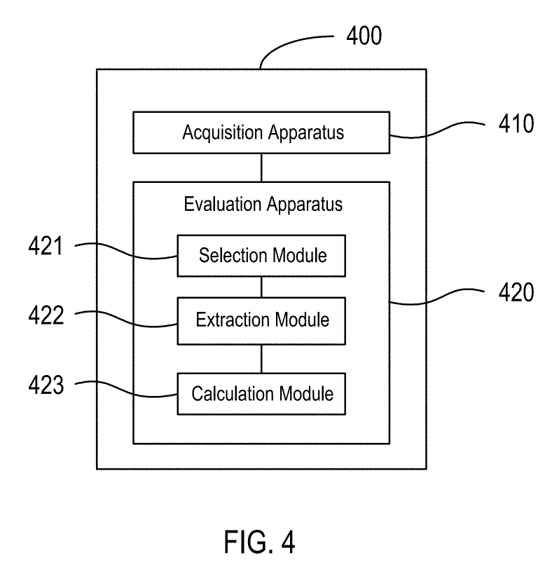

FIG. 4 is a block diagram illustrating a system for evaluating a health condition of an Internet user according to some embodiments of the disclosure.

As illustrated in FIG. 4, system 400 includes an acquisition apparatus 410 and an evaluation apparatus 420. In one embodiment, the acquisition apparatus 410 acquires Internet activity data during a set period of history for a user to be tested among a plurality of users. In one embodiment, the evaluation apparatus 420 evaluates the health condition of the user to be tested based on the Internet activity data acquired by the acquisition apparatus 410.

In the illustrated embodiment, evaluation apparatus 420 includes a selection module 421, an extraction module 422 and a calculation module 423. In one embodiment, the selection module 421 selects sample users from the plurality of users according to specified Internet activity data in the Internet activity data. In one embodiment, the extraction module 422 extracts characteristic data of the user to be tested from the Internet activity data and characteristic data of the sample users selected by the selection module 421. In one embodiment, the calculation module 423 calculates the health index of the user to be tested by using the characteristic data extracted by the extraction module 422 as parameters of a preset health index calculation model.

In some embodiments, the selection module 421 includes a first selection unit and a second selection unit. In one embodiment, the first selection unit selects a positive sample user from the plurality of users according to a first specified Internet activity data in the Internet activity data, and the positive sample user does not include the user to be tested. In one embodiment, the second selection unit selects a negative sample user from the plurality of users according to the second specified Internet activity data in the Internet activity data, and the negative sample user does not include the user to be tested.

On this basis, in other embodiments, the selection module 421 can further include an elimination unit and a balancing unit. In one embodiment, the elimination unit eliminates overlapping sample users from the positive sample users and the negative sample users respectively, and the overlapping sample user refers to a sample user who is both a positive sample user and a negative sample user. In one embodiment, the balancing unit balances the ratio of the number of the positive sample user to the negative sample user so that the ratio of the numbers can be within a set range.

For example, the first specified Internet activity data may be purchasing activity data under a sports category within a preset first period of history, while the second specified Internet activity data may be the activity data of searching and browsing a medical registration website in a preset second period of history.

In some embodiments, the calculation module 423 includes a training unit, a prediction unit and a normalization unit. In one embodiment, the training unit trains the health index calculation model by applying the characteristic data of the sample users to obtain a parameter value in the health index calculation model. In one embodiment, the prediction unit predicts the health probability of the user to be tested by using the characteristic data of the user to be tested as the input of the health index calculation model based on the parameter value obtained by the training unit as the parameter. In one embodiment, the normalization unit normalizes the health probability (predicted by the prediction unit) of the user to be tested, in order to obtain the health index of the user to be tested.

The characteristic data can comprise any one or more of the body mass index (BMI), a degree of an addiction to gaming, a degree of preference for junk foods, age, or sex, whether the user stays up late frequently, the frequency of purchasing medical products over a given time period (e.g., the last two weeks), and whether the user performs manual labor.

The health condition of the user is evaluated by the system for evaluating the health condition of the Internet user provided by the embodiment of the disclosure based on the Internet activity data, which establishes a new mode for evaluating the health condition, with low cost, high feasibility and fast updates. Moreover, in one embodiment, the system for evaluating a health condition of an Internet user is capable of objectively reflecting the health condition of the user to be tested, thus the reliability of the health condition evaluation result is higher.

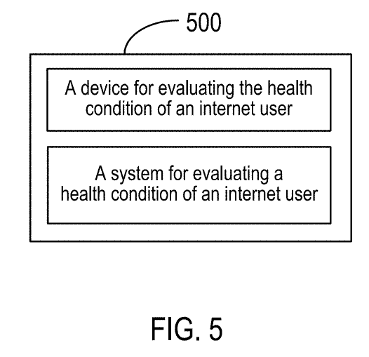

FIG. 5 is a block diagram illustrating a device for evaluating a health condition of an Internet user according to some embodiments of the disclosure.

As illustrated in FIG. 5, the device 500 comprises a system for evaluating the health condition of the Internet user. The system for evaluating the health condition of the Internet user can be any system for evaluating the health condition of the Internet user in the above embodiments of the disclosure.

The system for evaluating the health condition of the Internet user is used for acquiring Internet activity data during a set period of history for a user to be tested among a plurality of users, and evaluating the health condition of the user to be tested based on the acquired Internet activity data.

The device for evaluating a health condition of an Internet user can be a computer, server, etc.

Based on the Internet activity data of the user, the health condition of the user can be evaluated by the device for evaluating the health condition of an Internet user provided by the embodiment of the disclosure, comprising a system for evaluating the health condition of the Internet user, which establishes a new mode for evaluating the health condition, with low cost, high feasibility and fast updates. Moreover, in one embodiment, the device for evaluating a health condition of an Internet user is capable of objectively reflecting the health condition of the user to be tested, thus the reliability of the health condition evaluation result is higher.

The above are only embodiments of the disclosure, which are not intended to limit the scope of the disclosure. Any alterations, equivalent replacements and improvements, without departing from the spirit and principle of the disclosure shall fall within the protection scope of the disclosure.

What is claimed is:

1. A method comprising:
acquiring Internet activity data associated with a plurality of users, the plurality of users including a first user;
selecting a set of sample users from the plurality of users based on a plurality of specified Internet activities identified in Internet activity data associated with the first user;
extracting, from the Internet activity data, characteristic data for the first user and the set of sample users;
utilizing the characteristic data as at least one parameter of a health index calculation model; and
calculating a health index for the first user based on the health index calculation model.

2. The method of claim 1 wherein characteristic data comprises one of e-commerce data, web browsing data, body mass index data, a degree of an addiction to gaming, a degree of preference for junk foods, age, or sex, an indication of whether a user stays up late frequently, the frequency of purchasing medical products over a given time period, and whether a user performs manual labor.

3. The method of claim 1 wherein acquiring Internet activity data associated with a plurality of users comprises acquiring Internet activity data captured during a predefined period, the predefined period selected based on the type of the Internet activity data.

4. The method of claim 1, wherein selecting a set of sample users comprises:
selecting a set of positive sample users based on a first specified Internet activity; and
selecting a set of negative sample users based on a second specified Internet activity.

5. The method of claim 4, wherein selecting a set of sample users further comprises:
identifying a set of overlapping sample users appearing in both the set of positive sample users and the set of negative sample users;
eliminating the overlapping sample users from the set of positive sample users and the set of negative sample users; and
balancing the ratio of the number of the positive sample users to the negative sample users according to a set ratio threshold.

6. The method of claim 4, wherein the first specified Internet activity comprises purchasing activity associated with a sports category within a preset first period of history and the second specified Internet activity comprises searching and browsing a medical registration website in a preset second period of history.

7. The method of claim 1, wherein calculating a health index for the first user based on the health index calculation model comprises:
training the health index calculation model using the characteristic data of the sample users to obtain a parameter of the health index calculation model;
predicting a health probability of the first user using the characteristic data of the first user as an input to the health index calculation model; and
normalizing the health probability of the first user to obtain the health index of the first user.

8. The method of claim 7, wherein the health index calculation model comprises a random forest.

9. The method of claim 7, wherein normalizing the health probability of the first user comprises:
calculating a maximum heath probability and a minimum health probability for a set of users including the first user; and
normalizing the health probability of the first user based on the maximum health probability and minimum health probability.

10. The method of claim 1, wherein extracting characteristic data of a user comprises:
calculating a total purchasing frequency of a user with respect to a category of goods;
calculating a threshold based on a first quartile, a third quartile, and an interquartile range of total purchasing frequency of the user; and
determining a degree of preference for the category of goods based on the threshold.

11. An apparatus comprising:
one or more processors; and
a non-transitory memory storing computer-executable instructions therein that, when executed by the processors, cause the apparatus to perform the operations of:
acquiring Internet activity data associated with a plurality of users, the plurality of users including a first user;
selecting a set of sample users from the plurality of users based on a plurality of specified Internet activities identified in Internet activity data associated with the first user;
extracting, from the Internet activity data, characteristic data for the first user and the set of sample users;
utilizing the characteristic data as at least one parameter of a health index calculation model; and
calculating a health index for the first user based on the health index calculation model.

12. The apparatus of claim 11 wherein characteristic data comprises one of e-commerce data, web browsing data, body mass index data, a degree of an addiction to gaming, a degree of preference for junk foods, age, or sex, an indication of whether a user stays up late frequently, the frequency of purchasing medical products over a given time period, and whether a user performs manual labor.

13. The apparatus of claim 11 wherein acquiring Internet activity data associated with a plurality of users comprises acquiring Internet activity data captured during a predefined period, the predefined period selected based on the type of the Internet activity data.

14. The apparatus of claim 11, wherein selecting a set of sample users comprises:
selecting a set of positive sample users based on a first specified Internet activity; and
selecting a set of negative sample users based on a second specified Internet activity.

15. The apparatus of claim 14, wherein selecting a set of sample users further comprises:
identifying a set of overlapping sample users appearing in both the set of positive sample users and the set of negative sample users;
eliminating the overlapping sample users from the set of positive sample users and the set of negative sample users; and
balancing the ratio of the number of the positive sample users to the negative sample users according to a set ratio threshold.

16. The apparatus of claim 14, wherein the first specified Internet activity comprises purchasing activity associated with a sports category within a preset first period of history and the second specified Internet activity comprises searching and browsing a medical registration website in a preset second period of history.

17. The apparatus of claim 11, wherein calculating a health index for the first user based on the health index calculation model comprises:
training the health index calculation model using the characteristic data of the sample users to obtain a parameter of the health index calculation model;
predicting a health probability of the first user using the characteristic data of the first user as an input to the health index calculation model; and
normalizing the health probability of the first user to obtain the health index of the first user.

18. The apparatus of claim 17, wherein the health index calculation model comprises a random forest.

19. The apparatus of claim 17, wherein normalizing the health probability of the first user comprises:
calculating a maximum heath probability and a minimum health probability for a set of users including the first user; and
normalizing the health probability of the first user based on the maximum health probability and minimum health probability.

20. The apparatus of claim 11, wherein extracting characteristic data of a user comprises:
calculating a total purchasing frequency of a user with respect to a category of goods;
calculating a threshold based on a first quartile, a third quartile, and an interquartile range of total purchasing frequency of the user; and
determining a degree of preference for the category of goods based on the threshold.
